(19) United States
(12) Patent Application Publication
(10) Pub. No.: US 2026/0036256 A1
(43) Pub. Date: Feb. 5, 2026

(54) POST HANGER

(71) Applicant: Hang Dude LLC, FORT WORTH, TX (US)

(72) Inventor: ERIC Q WRIGHT, FORT WORTH, TX (US)

(73) Assignee: Hang Dude LLC, FORT WORTH, TX (US)

(21) Appl. No.: 19/199,479

(22) Filed: May 6, 2025

Related U.S. Application Data
(63) Continuation-in-part of application No. 19/049,863, filed on Feb. 10, 2025, now abandoned.
Application No. 19/049,863 is a continuation of application No. 19/043,862, filed on Feb. 3, 2025, now abandoned.
(60) Provisional application No. 63/678,807, filed on Aug. 2, 2024.

(51) Int. Cl. F16M 13/02

(52) U.S. Cl. CPC F16M 13/022

(57) ABSTRACT

A hanger includes three rods connected end-to-end at roughly 90-degrees to form a U-shaped hook. The lengths of the rods are preconfigured for a compatible post to enable the hook to engage the post by sliding the hook about the outer perimeter of the post with a slight gap between rods and surfaces of the post such that two of the rods will engage opposing surfaces of the post due to a gravitational torque on the rods, pinching the post between the engaging rods and thereby holding the hanger in place on the post. A load may be suspended from a load arm extending from one of the engaging rods, and may thereby augment the torque and pinching force. The point the load arm extends from the engaging rod is roughly at the midpoint of the post.

### CROSS-REFERENCE TO RELATED APPLICATIONS

This application is a continuation in part of U.S. patent application Ser. No. 19/049,863, filed on Feb. 10, 2025, which is a continuation of U.S. patent application Ser. No. 19/043,862, filed on Feb. 3, 2025, which claims the benefit of U.S. Provisional Application No. 63/678,807, filed on Aug. 2, 2024.

### BACKGROUND AND SUMMARY

This invention pertains generally to technology for hanging objects to posts. More specifically, the invention is directed to a hanger comprising a roughly rectangular engagement portion with three closed sides and an open side. The open side is dimensioned slightly larger than the target post the hanger is to engage. Two opposing closed sides are configured to engage opposing sides of the post (the “front” and “back” sides). An item-hanging portion extends from the front side of the engagement portion. The closed sides are dimensioned such that when the hanger is engaged with a post, a torque on the hanger will cause the post-engaging sides to frictionally engage the front and back surfaces of the post, holding the hanger in place.

It is well known that hanging flower pots or flags and the like from posts, columns, pillar, poles, and the like (collectively herein, “posts”) can improve the aesthetic or utility of a space. For instance, it is common to hang plants off posts in a backyard garden to create an “oasis” feel or to provide a ready herb garden. Flags may be suspended for decorative purposes. Lights may be fixed to posts to provide lighting for safety or ambience. And so on.

Conventional means for suspending items off a post include fasteners, such as screws and nails and bolts, that affix to a post. These can damage the post and are not easily removed or moved. Clamps may be used to lessen the damage. But they too are relatively cumbersome to install and move.

Accordingly, it is an object of the present invention to provide a post hanger that may be easily installed, removed, and moved without undue wear and tear to the post.

In one aspect of the invention, a post hanger includes a U-shaped hook that is defined by three rods serially connected at roughly right angles to provide: a front rod adjacent to the open side, a back rod adjacent to the open side and opposed to the front rod, and a connecting rod spanning a distance between the front rod and back rod and joining the front and back rods together on the side opposite the open side. The U-shaped hook is configured to engage a rectangular post. In an aspect of the invention, the front, connecting, and back rods are substantially coplanar and the distance between the front and back rods is about 100-110% of the width of the post.

In an aspect of the invention, a load arm (such as a rod or hook) extends from the front rod and is configured to support an item when the post hanger is engaging a post. The point at which the load arm extends from the front rod (the “extension point”) is spaced apart from the connection point between the front rod and connecting rod. In an aspect of the invention, the distance of the extension point from the connection point between the front rod and connecting rod is about 45-55% of the length of the connecting rod, to place the extension point at about the mid point of the post. In an aspect of the invention, the load arm is a rod that is substantially coplanar with the front, connecting, and back rods. In an aspect of the invention, the load arm is a rod that extends at greater than 5 degrees from the common plane of the coplanar front, connecting, and back rods.

### BRIEF DESCRIPTION OF THE DRAWINGS

These and other features, aspects, and advantages of the present invention will become better understood with reference to the following description, appended claims, and accompanying drawings where:

FIGS. 1A-1C are various views illustrating an exemplary post-engaging hanger (a “post hanger”) engaging a post according to an aspect of the invention.

FIG. 2 is a 3D perspective illustrating the exemplary post hanger separate from the post.

FIG. 3 is a 3D perspective illustrating another exemplary post hanger according to an aspect of the invention.

FIG. 4 is a 3D perspective illustrating another exemplary post hanger according to an aspect of the invention.

FIG. 5 is a top view illustrating an exemplary post hanger fit about a post.

FIG. 6 is a top view illustrating an exemplary post hanger fit about a post.

FIG. 7 is a 3D perspective illustrating a post hanger with a coplanar post hook and load arm.

FIG. 8 is a 3D perspective illustrating a post hanger with a coplanar post hook with load arm that is oriented off plane.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112 (f). Claims that include the “means for [function]” language but also recite the structure for performing the function are not means-plus-function claims governed by § 112 (f). Claims that include the “step for [function]” language but also recite an act for performing the function are not step-plus-function claims governed by § 112 (f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

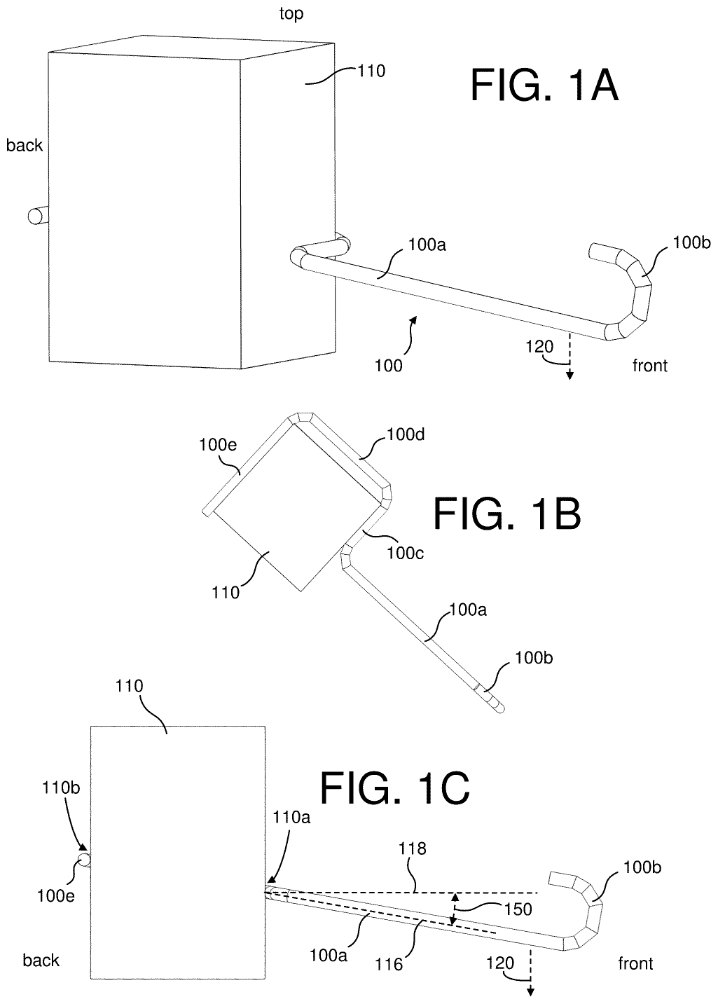

FIG. 1A is a 3D perspective illustrating an exemplary hanger 100 engaging a post 110. FIG. 1B is a top view, FIG. 1C is a side view. The hanger 100 includes three substantially straight elongate side segments 100e, 100d, 100c roughly shaped in the from of a rectangle with one open side and one partially open side; roughly, a right-angled U-shaped hook configured to engage a post. A first side 100e, the “back” rod, is configured to engage the “back” surface 110b of the post 110. A third side 100c, the “front” rod, is configured to engage the “front” surface 110a of the post 110. A second side 100d, the “connecting” rod, connects the first side 100c to the third side 100e: The first side 100c connects to the second side 100d at roughly a 90-degree angle and the second side 100d connects to the third side 100e at roughly a 90-degree angle, thereby roughly forming three sides of a rectangle with an open side roughly the same length as the second side 100d. A substantially straight elongate load rod 100a extends out from the first side 100c and terminates with a retaining hook 100b. (As used herein, the “front” of the post and the hanger's post-engaging U-hook refers to the side from which an item is suspended from the hanger on the post. The “back” is the opposite side to the front.)

A downward force 120 applied to the load rod 100a while the front rod 100c is engaged with the front surface 110a of the post 110 will produce a torque about the longitudinal axis of the front rod 100c causing the back rod 100e to engage the back surface 110b of the post 110. (The force 120 is indicated by a dashed arrow in FIGS. 1A and 1C.) The torque caused by the downward force 120 in turn forces the back rod 110b toward the back surface 110b and the front rode 100c toward the front surface 110a which holds the hanger 100 in place on the post 110. It does this without the need for a fastener such as an adjustable clamp, screw, or nail.

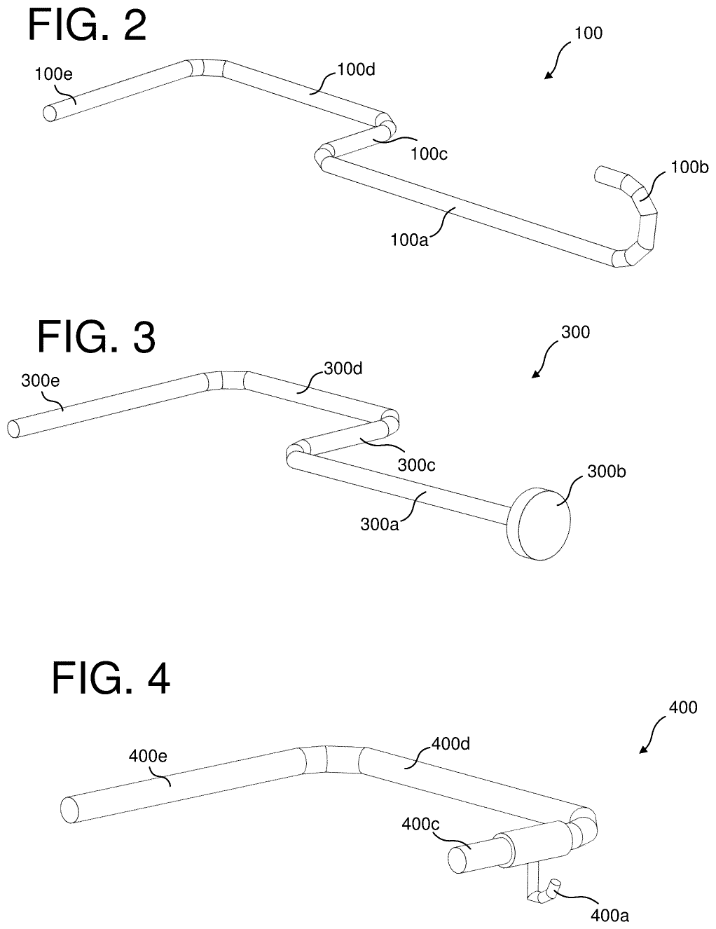

FIG. 2 is a 3D perspective illustrating the hanger 100 described with reference to FIGS. 1A-1C.

FIG. 3 is a 3D perspective illustrating another exemplary hanger 300. It is similar to the hanger 100 described with reference to FIGS. 1A-1C: the hanger 300 has a front rod 300c, a connecting rod 300d, and a back rod 300e together shaped roughly as a U-shaped hook. A load rod 300a extends out from the front rod 300a and terminates in a retaining disk 300b. The retaining hook 100b in FIG. 2 and the retaining disk 300b in FIG. 3 are both examples of a terminal retaining feature; namely, a feature at or near the terminal end of a load rod that provides an increased surface area relative to the load rod's cross-sectional area to help prevent items suspended from the load rod from sliding off the terminal end of the load rod. For example, a plant pot may be configured with a suspension chain connected to the pot at one end of the chain and to a hook at the other end. The hook may be placed on the load rod to suspend the pot from the load rod (thereby hanging the pot off a post engaged by the post hanger). The retaining feature provides a barrier to the hook sliding along the length of the load rod. The hook would have to jump off the load rod to clear the barrier. This is unlikely to happen under normal hanging condition, thus the retaining feature serves to retain the item on the hanger.

FIG. 4 is a 3D perspective illustrating another exemplary hanger 400. It is similar to the hanger 100 described with reference to FIGS. 1A-1C: the hanger 400 has a front rod 400c, a connecting rod 400d, and a back rod 400e together shaped roughly as a U-shaped hook. Instead of a load rod extending from the front rod, this hanger embodiment 400 has a load hook 400a extending down from the front rod 400c.

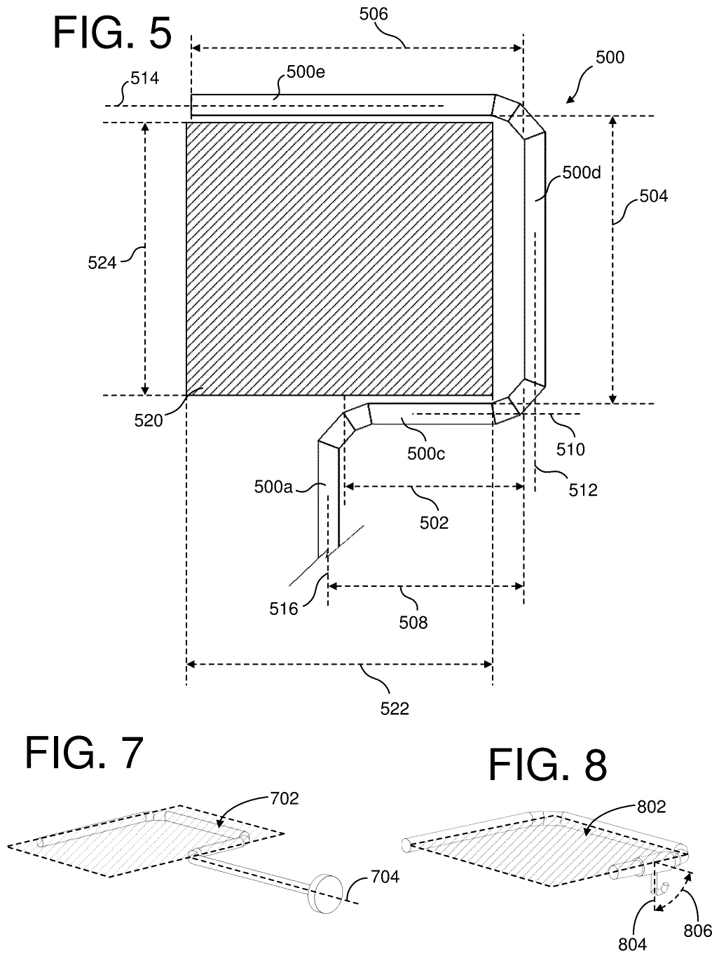

FIG. 5 is a top view illustrating the relative dimensions of an exemplary post hanger 500 and the rectangular post 520 it is configured to engage. The hanger 500 has a first rod 500c, a second rod 500d, and a third rod 500e serially connected to each other at roughly 90 degrees to form a U-shape. (For sake of convenience, each rod 500c, 500d, 500e is defined with a “beginning” end and a “terminal” end. As illustrated, the terminal end of the first rod is connected to the beginning end of the second rod and the terminal end of the second rod is connected to the beginning end of the third rod.) The rods 500c, 500d, 500e may be formed by bending a single rod into the three rod segments (as illustrated) or three separate rods may be joined together by, e.g., welds or threaded joints. As illustrated, the connections between the rods 500c, 500d, 500e have an inside bend radius that can be varied by bending technique and rod diameter (or other outer rod dimension if the rod has a non-circular cross section). Further, material may be removed at the inside bends to make the bends more square. The rods 500c, 500d, 500e each have a longitudinal axis 510, 512, 514 defined by the unbent portions of the rods. Each axis is roughly 90-degrees to the adjacent axis. The ends of the rods at the connections are the midpoints of the connections. The hanger 500 has a load rod 500a extending out from the first rod. (As illustrated, the load rod 500a extends from the beginning end of the first rod 500c. In other embodiments, the load rod 500a may extend from a different extension point on the first rod 500c.) The terminal end of the load rod 500a (not depicted in FIG. 5) may include a retaining feature as described above.

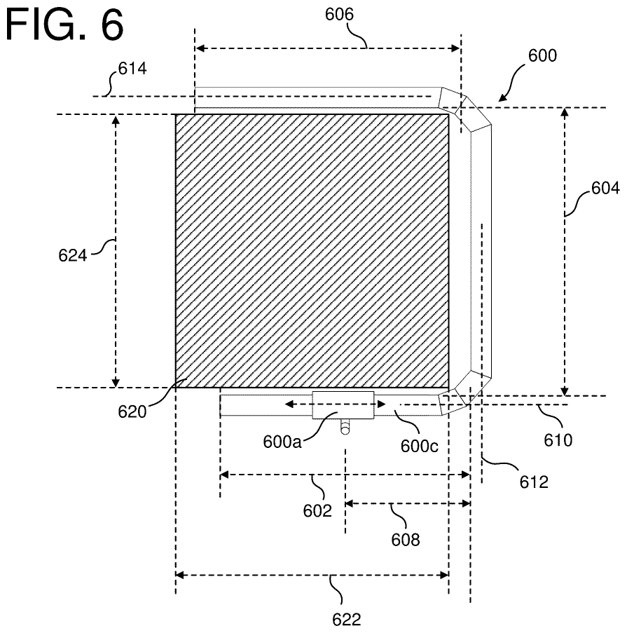

The dimensions of the hanger 500 are tuned to the rectangular post 520 it is configured to engage. The post 520 has two characteristic orthogonal dimensions 522, 524 (“length” 522 and “width” 524), which will be equal for a square post. The length 504 of the second rod 500d (the “connecting” rod) is slightly larger than the width 524 of the post. Preferably, the rod's length 504 is about 100-110% of the post's width 524. This enables the hanger's “U-hook” to fit about the post while allowing for some torque rotation relative to the post. In some embodiments, the load rod 500a is substantially coplanar with the first, second, and third rods 500c, 500d, 500e. (Herein, “substantially coplanar” means that the longitudinal axes 510, 512, 514, 516 all fall within a common plane within 5 degrees of that plane. The common plane is the plane fit to minimize angular deviations of the axes from the plane.) In these embodiments, there will be a slightly downward slope to the load rod 500a due to the torque rotation. (For instance, the load rod 100a in FIG. 1C is sloped down at an angle 150 between the load rod's longitudinal axis 116 and the normal 118 to the post's front surface 110a.) The extent of this downward slope depends on the difference between the inside width of the “U” (which is substantially equal to the length of the second rod 500d) and the width 524 of the post 520. In other embodiments, the load rod 500a may have an extension angle greater than 5 degrees out of the common plane of the first, second, and third rods 500c, 500d, 500e to, e.g., counter the sloping effect of the torque rotation. (Herein, the “extension angle” of the load rod means the angle the longitudinal axis 516 of the load rod 500a makes to the common plane of the substantially coplanar first, second, and third rods. FIG. 7 illustrates an example of a post hanger with a load arm that is coplanar with the front, connecting, and back rods. The load arm's longitudinal axis 704 is parallel to the common plane 702 of the front, connecting, and back rods. FIG. 8 illustrates and example of a post hanger with a load arm that is not coplanar with the front, connecting, and back rods. The load arm's longitudinal axis 804 is off the common plane 802 of the front, connecting, and back rods. The depicted extension angle 806 is about-90 degrees.)

The length 502 of the first rod 500c should be sufficient to allow the extension point (a length 508 from the terminal end of the first rod 500c) of the load rod 500a to be at or near the midpoint of the post's length 522. The length 506 of the third rod 500e should be greater than about 60% of the post's length 522 to better retain the hanger 500 in place on the post 520.

In a preferred embodiment for a square post of dimension “X”: the length 504 of the connecting rod 500d is 110%±10% of X, the length 502 of the front rod 500c is 55%±10% of the connecting rod's length 504, the length 506 of the back rod 500e is 90%±15% of the connecting rod's length 504, and the load rod 500a extends from the front rod 500c at a point 50%±10% of the connecting rod's length 504 from the beginning end of the connecting rod 500d.

FIG. 6 is a top view illustrating the relative dimensions of an exemplary post hanger 600 and the rectangular post 620 it is configured to engage. This is similar to the hanger 500 described with reference to FIG. 5. The hanger 600 has a first (“front”) rod 600c, a second (“connecting”) rod 600d, and a third (“back”) rod 600e serially connected to each other at roughly 90 degrees to form a U-shape. (For sake of convenience, each rod 600c, 600d, 600e is defined with a “beginning” end and a “terminal” end. As illustrated, the terminal end of the first rod is connected to the beginning end of the second rod and the terminal end of the second rod is connected to the beginning end of the third rod.) The rods 600c, 600d, 600e may be formed by bending a single rod into the three rod segments (as illustrated) or three separate rods may be joined together by, e.g., welds or threaded joints. As illustrated, the connections between the rods 600c, 600d, 600e have an inside bend radius that can be varied by bending technique and rod diameter. Further, material may be removed at the inside bends to make the bends more square. The rods 600c, 600d, 600e each have a longitudinal axis 610, 612, 614 defined by the unbent portions of the rods. Each axis is roughly 90-degrees to the adjacent axis and they are substantially coplanar. The ends of the rods at the connections are the midpoints of the connections. The hanger 600 has a load hook 600a extending from the first rod 600c. (As illustrated, the load hook 600a is pivotable and slidable along the first rod 600c so that the point from which it extends is variable. In other embodiments, the load hook 600a may extend from a fixed extension point on the first rod 600c.)

The dimensions of the hanger 600 are tuned to the rectangular post 620 it is configured to engage, similar to the hanger 500 described with reference to FIG. 5. The post 620 has two characteristic orthogonal dimensions 622, 624 (“length” 622 and “width” 624), which will be equal for a square post. The length 604 of the connecting rod 600d is slightly greater than the width 624 of the post. The length 602 of the front rod 600c should be sufficient to allow the extension point (a length 608 from the terminal end of the first rod 600c) of the load hook 600a to be at or near the midpoint of the post's length 622. The length 606 of the third rod 600e should be greater than about 50% of the post's length 622 to better retain the hanger 600 in place on the post 620.

In a preferred embodiment for a square post of dimension “X”: the length 604 of the connecting rod 600d is 105%±5% of X, the length 602 of the front rod 600c is 60%±15% of the connecting rod's length 604, the length 606 of the back rod 600e is 90%±10% of the connecting rod's length 604, and the load hook 600a extends from the front rod 600c at a point 55%±10% of the connecting rod's length 604 from the beginning end of the connecting rod 600d.

As described herein, a post hanger may be configured with a U-shaped hook with the opening of the hook tuned to snugly fit over a rectangular post such that a downward force on a side of the hook adjacent to the opening will cause torque and a slight rotation so that the two sides adjacent to the opening will pinch the post, thereby holding the hanger in place. While primarily designed for rectangular posts, the hanger disclosed herein may be adapted to any shaped post with flat front and back surfaces that are roughly parallel (e.g., a post having a cross section roughly the shape of a doubly-truncated circle, as in a roughly circular post modified, at least at some point, to have two opposing flat faces).

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A post hanger comprising:
(a) a first rod having a first beginning end, a first terminal end, a first longitudinal axis, and a first length;
(b) a second rod having a second beginning end, a second terminal end, a second longitudinal axis, and a second length;
(c) a third rod having a third beginning end, a third terminal end, a third longitudinal axis, and a third length;
(d) a load arm extending from the first rod at an extension point;
(e) wherein the first terminal end is connected to the second beginning end, thereby forming a first angle between the first longitudinal axis and the second longitudinal axis;
(f) wherein the second terminal end is connected to the third beginning end, thereby forming a second angle between the second longitudinal axis and the third longitudinal axis;
(g) wherein the first angle is greater than or equal to 80 degrees and less than or equal to 100 degrees;
(h) wherein the second angle is greater than or equal to 80 degrees and less than or equal to 100 degrees; and
(i) wherein the extension point is at a distance from the first terminal end that is greater than 30% of the second length and less than 70% of the second length.

2. The post hanger of claim 1 wherein the first rod, second rod, and third rod are substantially coplanar.

3. The post hanger of claim 1 wherein the first length is less than the second length.

4. The post hanger of claim 1 wherein the first length is less than or equal to 85% of the second length and greater than or equal to 45% of the second length.

5. The post hanger of claim 1 wherein the third length is less than or equal to 105% of the second length and greater than or equal to 75% of the second length.

6. The post hanger of claim 1 wherein the load arm is a load rod.

7. The post hanger of claim 6 wherein the load rod terminates in a retaining feature.

8. The post hanger of claim 6 wherein the first rod, second rod, third rod, and load rod are substantially coplanar.

9. The post hanger of claim 6 wherein:
(a) the first rod, second rod, and third rod are substantially coplanar with a common plane; and
(b) the load rod has an extension angle with the common plane greater than 5 degrees.

10. The post hanger of claim 9 wherein the extension angle is 10 degrees±5 degrees.

11. The post hanger of claim 1 wherein the load arm is a load hook.

12. The post hanger of claim 11 wherein the load hook is selectively positionable along the length of the first rod.

13. A method for making a post hanger, the method comprising:
(a) selecting a post width;
(b) determining a connecting-rod length based on the post width;
(c) determining a front-rod length based on at least one of the group consisting of the post width and the connecting-rod length;
(d) determining a back-rod length based on at least one of the group consisting of the post width and the connecting-rod length;
(e) determining a load-arm extension point based on at least one of the group consisting of the post width and the connecting-rod length;
(f) forming a front rod having the front-rod length at 90 degrees±5 degrees to a connecting rod having the connecting-rod length;
(g) forming a back rod having the back-rod length at 90 degrees±5 degrees to the connecting rod to place the joined front rod, connecting rod, and back rod into a “U” shape; and
(h) joining a load arm to the front rod at the load-arm extension point.

14. The method of claim 13 wherein:
(a) determining the connecting-rod length includes selecting a length that is 110%±10% of the post width;
(b) determining the front-rod length includes selecting a length from the group consisting 55%±10% of the connecting-rod length and 55%±10% of the post width.

15. The method of claim 13 wherein the front rod, connecting rod, and back rod are substantially coplanar with a common plane.

16. The method of claim 15 further comprising:
(a) determining a load-arm extension angle;
(b) positioning the load arm at the extension angle to the common plane.

17. The method of claim 15 wherein the forming steps are performed by bending a single rod into the front rod, connecting rod, and back rod.

18. A post hanger comprising:
(a) a front rod;
(b) a connecting rod;
(c) a back rod; and
(d) a load arm;
(e) wherein the front rod is connected to the connecting rod at 90 degrees±5 degrees, thereby forming a first connection point between the front rod and connecting rod;
(f) wherein the back rod is connected to the connecting rod at 90 degrees±5 degrees to place the joined front rod, connecting rod, and back rod into a “U” shape, thereby forming a second connection point between the back rod and connecting rod; and
(g) wherein load arm is connected to the front rod at an extension point spaced a first distance from the first connection point.

19. The post hanger of claim 18 wherein:
(a) the connecting rod has a connecting-rod length equal to a distance between the first connection point and the second connection point; and
(b) the first distance is 50%±15% of the connecting-rod length.

20. The post hanger of claim 18 wherein the front rod, connecting rod, and back rod are substantially coplanar.
